(19) United States
(12) Patent Application Publication
(10) Pub. No.: US 2017/0088785 A1
(43) Pub. Date: Mar. 30, 2017

(54) PROCESS FOR INJECTING BIOMETHANE INTO A NATURAL GAS NETWORK

(71) Applicant: L'Air Liquide, Societe Anonyme pour I'Etude et I'Exploitation des Procedes Georges Claude, Paris (FR)

(72) Inventors: Guénaël PRINCE, Saint Egreve (FR); Golo ZICK, Fontaine (FR)

(73) Assignee: L'Air Liquide, Societe Anonyme pour I'Etude et I'Exploitation des Procedes Georges Claude, Paris (FR)

(21) Appl. No.: 15/311,376

(22) PCT Filed: May 11, 2015
(86) PCT No.: PCT/FR2015/051230

§ 371 Date: Nov. 15, 2016

(30) Foreign Application Priority Data
May 15, 2014 (FR) 1454321

(51) Int. Cl. C10L 3/08; B01D 53/22; B01D 53/04; C10L 3/10

(52) U.S. Cl. CPC C10L 3/08; C10L 3/103; C10L 3/104; B01D 53/229; B01D 53/04; C10L 2290/141; C10L 2290/143; C10L 2290/547; C10L 2290/542; C10L 2290/58; B01D 2253/102; B01D 2256/12; B01D 2257/304

(57) ABSTRACT

A process for injecting biomethane into a network which has a gross calorific value of value X between X1 and X2, comprising the injection of nitrogen into the biomethane network before the injection of the biomethane into the network which has a gross calorific value of value X so as to reduce the calorific value of the biomethane network to a value between X1 and X2, with the nitrogen derived from the retentate of at least one membrane stage.

The present invention relates to a process for injecting biomethane into an L type natural gas network and to the corresponding plant thereof.

Biogas predominantly contains methane (CH₄) and carbon dioxide (CO₂), but also water, nitrogen, hydrogen sulfide, oxygen, and other organic compounds.

It is essential to develop various upgradings of the biogas in order to respond to the problems caused by global warming, on both a global and regional level, and also in order to increase the energy independence of the territories that produce it.

Biogas may, after slight treatment, be upgraded in the vicinity of the production site in order to provide heat, electricity or a mixture of both (cogeneration); the high content of carbon dioxide reduces its heating value, increases the compression and transport costs and limits the economic advantage of upgrading it to this local use.

A more thorough purification of the biogas enables a broader use thereof.

In particular, a more thorough purification of the biogas makes it possible to obtain a biogas that is purified to the specifications of natural gas; this highly purified biogas is referred to as “biomethane”. Biomethane thus supplements natural gas resources with a renewable portion produced at the heart of territories. It can be used for exactly the same uses.

The injection of produced biomethane is booming. However, in France for example two types of natural gas networks exist: the H type (high calorific value) network and the L type (low calorific value) network. The biogas purification units produce a biomethane containing 2.5 mol % CO₂ in CH₄ mainly, with therefore a gross calorific value and a Wobbe index that are too high for being injected into the L type networks.

Hence, one problem that is faced is that of providing an improved process for injecting biomethane into the natural gas network.

One solution of the present invention is a process for injecting biomethane into a network having a gross calorific value of value X between X1 and X2, comprising the injection of nitrogen into the biomethane network before the injection of the biomethane into the network having a gross calorific value of value X so as to lower the calorific value of the biomethane network to a value between X1 and X2, with the nitrogen resulting from the retentate of at least one membrane stage.

One specific solution of the invention is a process for injecting biomethane into an L type natural gas network, comprising the injection of nitrogen into the biomethane network before the injection of the biomethane into the natural gas network so as to lower the gross calorific value of the biomethane network to a value between 9.5 and 10.5 kWh/Nm³, with the nitrogen resulting from the retentate of at least one membrane.

Depending on the case, the process according to the invention may have one or more of the following features:
the membrane stage is supplied with air resulting from an internal network of the process or resulting from an air compressor; and the amount of nitrogen injected into the biomethane network is controlled via a control valve located on the feed of the membrane stage or via the adjustment of the production capacity of the air compressor. In the case where a control valve is used, the set point of the flow rate of nitrogen to be injected is calculated knowing the content of methane in the natural gas, and also its flow rate, these two parameters making it possible to deduce the GCV of the gas when CH₄ is the only fuel present. An “internal network” is preferably understood to mean air used for the operation of instruments used in the process such as the valves; reference may also be made to “instrument air”;
the gas stream passing through the membrane stage is air that is dried so that the nitrogen, retentate of the membrane stage, mixed with the biomethane meets the specifications of the network having a gross calorific value of value X; and that is de-oiled at a pressure greater than or equal to the pressure of the biomethane network, in general between 5 and 15 bar. In general, the air is dried so as to have a dew point below −5° C. at the maximum pressure of the injection network;
the purity of the nitrogen injected into the biomethane network is controlled via an analysis of the concentration of oxygen in the nitrogen retentate, or by a measurement of the pressure of the retentate. For this, use is preferably made of a control loop, the actuator of which is a control valve installed on the retentate of the membrane, with the control valve making it possible to adjust the operating pressure of the membrane. An oxygen analyzer located on the nitrogen retentate makes possible to control the purity and constitutes the measurement of the control loop. The oxygen purity may also be deduced by the measurement of the pressure of the retentate. The measurement of the control loop is then constituted by a pressure sensor;
the membrane from which the nitrogen-enriched retentate is derived also produces an oxygen-enriched stream;
the oxygen-enriched stream is injected into a digester that produces biogas or upstream of activated carbon filters of a biogas purification unit. A “digester” is understood to mean an anaerobic production of biogas. This injection of oxygen-enriched stream facilitates the desulfurization of the biogas actually within the digesters, or when the oxygen-rich stream is injected into a biogas purification unit it facilitates the abatement of H₂S by the activated carbon.

Another subject of the present invention is a plant for injecting biomethane into a network having a gross calorific value of value X, comprising:
a biomethane production unit;
a biomethane network;
a network having a gross calorific value of value X;
a nitrogen-selective membrane enabling the production of a nitrogen-enriched retentate from an air stream;
a system for producing air at a pressure greater than or equal to the pressure of the biomethane network;
a first injection means for injecting the retentate of the membrane into the biomethane network;
a second injection means for injecting the biomethane resulting from the biomethane network into the network having a gross calorific value of value X,
   with the second injection means downstream of the first injection means according to the flow direction of the biomethane in the biomethane network.

One specific plant according to the invention is a plant for injecting biomethane into an L type natural gas network, comprising:
a biomethane production unit;
a biomethane network;
an L type natural gas network;
a nitrogen-selective membrane enabling the production of a nitrogen-enriched retentate from an air stream;
a system for producing air at a pressure greater than or equal to the pressure of the biomethane network;
a first injection means for injecting the retentate of the membrane into the biomethane network;
a second injection means for injecting the biomethane resulting from the biomethane network into the L type natural gas network,
   with the second injection means downstream of the first injection means according to the flow direction of the biomethane in the biomethane network.

Depending on the case, the plant according to the invention may have one or more of the features below:
said plant comprises an oxygen concentration analyzer located on the retentate of the membrane upstream of the first injection point, a pressure sensor located on the retentate of the membrane upstream of the first injection means, and a control valve located on the retentate of the membrane downstream of the analyzer and upstream of the first injection means;
said plant comprises a control valve on the feed stream of the membrane;
the system for producing compressed air successively comprises, in the flow direction of the air, an air inlet, an air compressor, a compressed gas cooling system, a condensate separator, an activated carbon filter that makes it possible to remove the residual oil particles, a particle filter that makes it possible to remove the activated carbon particles, a dryer and a compressed air storage tank.

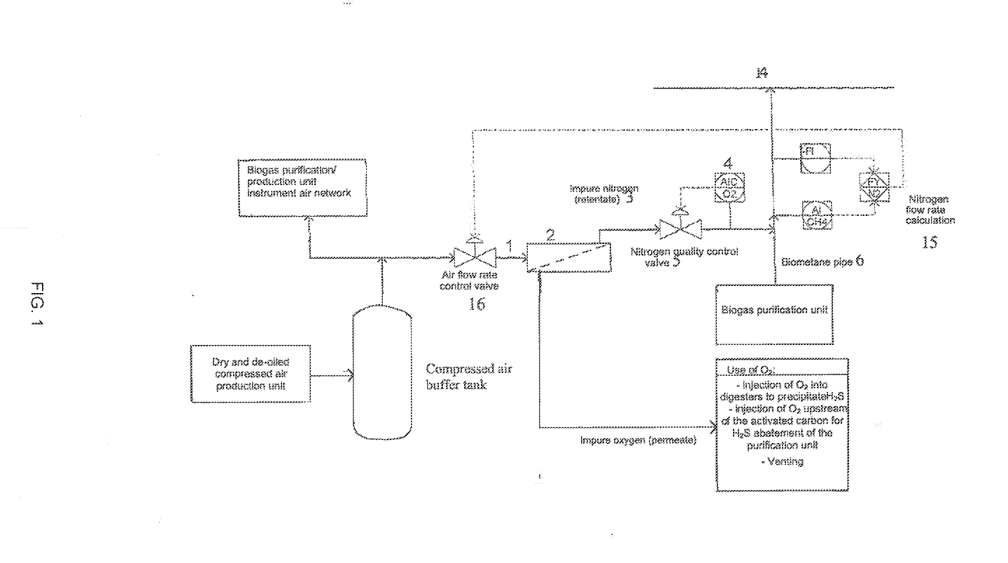

The invention will be described in greater detail using FIGS. 1, 2 and 3.

FIG. 1 represents a plant according to the invention when the air used for producing the nitrogen is taken from an instrument air network.

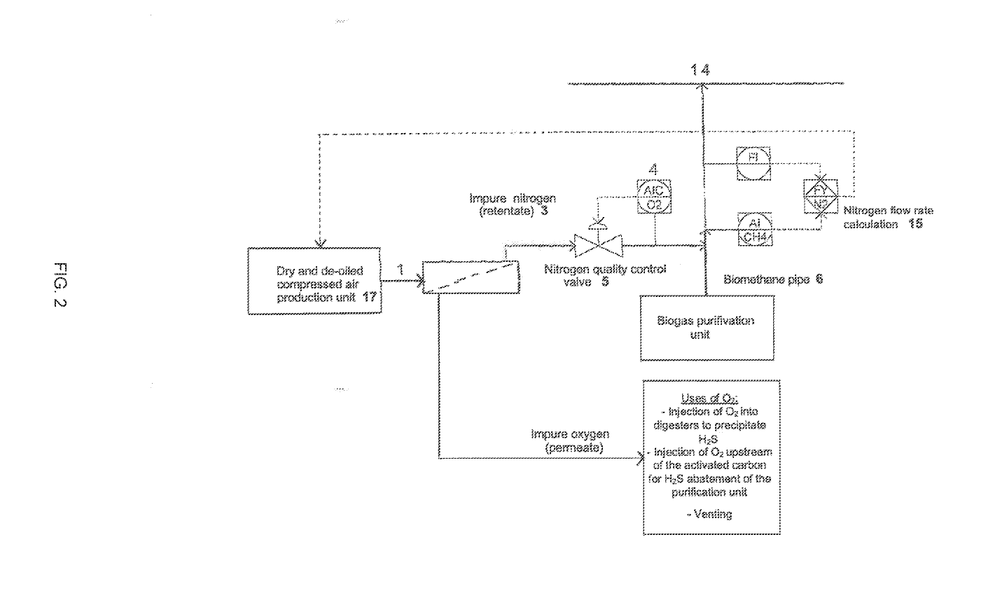

FIG. 2 represents a plant according to the invention when the air used for producing the nitrogen is produced by a dedicated compressor.

In both scenarios, the air stream 1 supplies a membrane stage consisting of one or more membranes in parallel 2 and enabling the production of pressurized nitrogen. A nitrogen-enriched retentate 3 is recovered from the membrane. Depending on the amount of oxygen tolerated in the biomethane network, a more or less pure nitrogen is produced. In order to control this purity of the nitrogen, the retentate passes into an analyzer 4 that measures the oxygen concentration and the purity of the nitrogen injected into the biomethane network 6 is controlled via a control valve 5. The stream of nitrogen produced is controlled 15 by adjusting the flow rate of air entering the membrane stage, either via a control valve 16 (FIG. 1), or by adjusting the production capacity of the air compressor 17 (FIG. 2); a flowmeter and also an analyzer of CH₄ from the biomethane make it possible to check that the GCV complies with the injection specification.

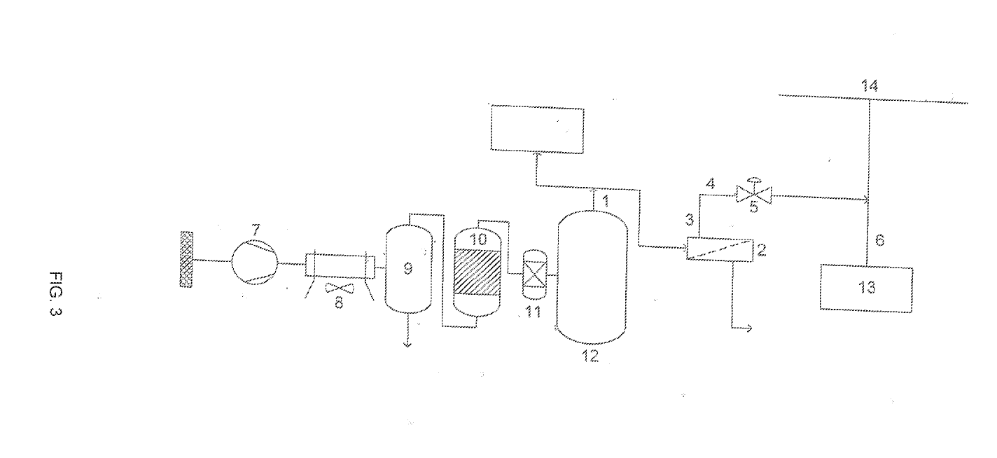

FIG. 3 depicts what the air production system may be: the air may be compressed to a pressure greater than 5 bar in an air compressor 7, then cooled 8. The air stream thus compressed and cooled is introduced into a condensate separator 9, before passing successively through an adsorber 10 comprising activated carbon so as to eliminate the residual oil particles and through a particle filter 11 so as to eliminate the activated carbon particles. A compressed and purified air stream is then recovered which may be stored 12 before supplying the membrane 2.

Tables 1 and 2 below illustrate the need for injection of nitrogen in order to comply with the biomethane injection specification from the point of view of the GCV and the Wobbe index in L gas networks:

TABLE 1

| | | Without | With |
|---|---|---|---|
| Biomethane composition | | N₂ | N₂ |
| N₂ | % mol. | 0.0% | 6.0% |
| O₂ | % mol. | 0.0% | 0.0% |
| CO₂ | % mol. | 2.5% | 2.5% |
| CH₄ | % mol. | 97.5% | 91.5% |
| Total | | 100.0% | 100.0% |
| GCV | kWh/Nm³ | 10.81 | 10.15 |
| Wobbe index | kWh/Nm³ | 14.22 | 13.06 |

TABLE 2

| L gas GRT specification | | |
|---|---|---|
| max. GCV | kWh/Nm³ | 10.5 |
| max. Wobbe index | kWh/Nm³ | 13.06 |

1-12. (canceled)

13. A process for injecting biomethane into a biomethane network that has a gross calorific value of value X between X1 and X2, comprising the steps of:
injecting biomethane having a gross calorific value greater than X2 into a biomethane network; and
injecting nitrogen into the biomethane network in an amount sufficient to achieve an overall calorific value of the injected biomethane and nitrogen of between X1 and X2, wherein the nitrogen being injected is obtained from a retentate of at least one membrane stage.

14. The process for injecting biomethane of claim 13, wherein X1=9.5 kWh/Nm³ and X2=10.5 kWh/Nm³.

15. The process of claim 13, further comprising the steps of:
feeding, to the at least one membrane stage, air from an internal network of the process or from an air compressor;
separating the fed air into an impure oxygen permeate and an impure nitrogen retentate, the impure nitrogen retentate being the nitrogen that is injected into the biomethane network; and
controlling the amount of nitrogen injected into the biomethane network via a control valve located on a feed of the at least one membrane stage or via adjustment of a production capacity of the air compressor.

16. The process of claim 15, wherein upstream of the compressor the air is dried and de-oiled and is at a pressure greater than or equal to a pressure of the biomethane network.

17. The process of claim 15, wherein a purity of the nitrogen injected into the biomethane network is controlled based upon a concentration of oxygen in the impure nitrogen retentate or upon a pressure of the impure nitrogen retentate.

18. The process of claim 13, wherein the membrane from which the nitrogen-enriched retentate is obtained also produces an oxygen-enriched stream.

19. The process of claim 18, wherein the oxygen-enriched stream is injected into a digester that produces biogas.

20. The process of claim 18, wherein the oxygen-enriched stream is injected upstream of an activated carbon filter of a biogas purification unit to facilitate abatement of H2S by the activated carbon filter from biogas fed to the biogas purification unit.

21. A plant for injecting biomethane into a network having a gross calorific value of value X, comprising:
a biomethane production unit;
a biomethane network in fluid communication with the biomethane production unit, the biomethane network having a gross calorific value of value X;
a nitrogen-selective membrane that is adapted and configured to produce a nitrogen-enriched retentate from an air stream, the biomethane network being in fluid communication with the nitrogen-selective membrane and receiving the nitrogen-enriched retentate therefrom;
a system for producing compressed air at a pressure greater than or equal to a pressure of the biomethane network, the system for producing compressed air being in upstream flow communication with the nitrogen-selective membrane.

22. The plant of claim 21, wherein said plant further comprises:
an oxygen concentration analyzer located on the retentate of the membrane upstream of the biomethane network, the analyzer being adapted and configured to measure an oxygen concentration of the membrane retentate;
a pressure sensor located on the retentate of the membrane upstream of the biomethane network, the pressure sensor being adapted and configured to measure a pressure of the membrane retentate, and
a control valve located on the retentate of the membrane downstream of the analyzer and upstream of the biomethane network, the control valve controlling the air stream fed to the membrane.

23. The plant of claim 21, wherein the system for producing compressed air is fed with air and comprises, in a flow direction of the air: an air inlet, an air compressor, a compressed gas cooling system, a condensate separator, an activated carbon filter adapted and configured to remove residual oil particles from the fed air, a particle filter adapted and configured to remove activated carbon particles from the fed air, a dryer, and a compressed air storage tank.
